(19) United States
(12) Patent Application Publication
(10) Pub. No.: US 2016/0207429 A1
(43) Pub. Date: Jul. 21, 2016

(54) SEAT CUSHION

(71) Applicant: FAURECIA AUTOMOTIVE SEATING, LLC., Troy, MI (US)

(72) Inventors: Robert C. FITZPATRICK, Holland, MI (US); Christopher L. HOGG, Holland, MI (US); Adam M. DECK, Holland, MI (US)

(21) Appl. No.: 14/908,670

(22) PCT Filed: Jul. 25, 2014
(86) PCT No.: PCT/US2014/048237

§ 371 Date: Jan. 29, 2016

Related U.S. Application Data
(60) Provisional application No. 61/860,442, filed on Jul. 31, 2013.

(51) Int. Cl. B60N 2/44; B60N 2/68

(52) U.S. Cl. CPC B60N 2/4415; B60N 2/686

(57) ABSTRACT

A vehicle seat (10) comprising a deformable elastic layer (24) including a series of deformable strips (S) made of elastic material and arranged to lie in side-by-side relation to one another and a layer-firmness changer (25) including a strip deformer (28) comprising several inflatable bladders (B), each inflatable bladder (B) being positioned to lie in a bladder-receiving space provided between a companion pair of adjacent deformable strips (S) included in the deformable elastic layer (24) and adapted to be coupled in fluid communication to a pressurized fluid source (20) and a strip retainer (26) configured to provide means for retaining the series of deformable strips (S) in side-by-side relation to one another during deformation of the deformable strips (S) caused in one instance by inflation of each inflatable bladder (B).

### BACKGROUND

The present disclosure relates to a vehicle seat, and particularly to a cushion in such a vehicle seat. More particularly, the present disclosure relates to a seat cushion having a variable shape.

### SUMMARY

According to the present disclosure, a vehicle seat includes an occupant-support base and a seat frame for the occupant-support base. In an illustrative embodiment, the occupant-support base is configured to provide a seat bottom arranged to lie above the seat frame.

In illustrative embodiments, the seat bottom includes a deformable layer comprising a series of deformable strips and a layer-firmness changer operable by a seat passenger to change the firmness of the deformable layer. The deformable layer and the layer-firmness changer cooperate to form a variable-firmness cushion included in the seat bottom.

In illustrative embodiments, the deformable strips are held together in a side-by-side formation in a strip-containment bag or other strip retainer included in the layer-firmness changer. The layer-firmness changer also includes a strip deformer comprising a series of inflatable bladders located in spaces provided between pairs of adjacent deformable strips. These bladders can be inflated or deflated to control deformation of the deformable strips and thus regulate the firmness of the deformable layer included in the variable-firmness cushion.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a vehicle seat in accordance with the present disclosure showing a first embodiment of an occupant-support base (e.g., seat bottom) including a seat pan mounted on an underlying seat frame coupled to a floor of a vehicle and a pad (e.g., cushion) mounted on the underlying seat pan and showing that the pad includes a variable-firmness cushion located inside a cushion cover and coupled to a pressurized air source that can be operated (e.g., as suggested in FIGS. 3-5) to vary the firmness of the occupant-support base by a passenger seated on the vehicle seat;

FIG. 2 is an enlarged, exploded perspective assembly view of the pad of FIG. 1 showing that the variable-firmness cushion includes a series of spaced-apart deformable strips (e.g., a series of six spaced-apart deformable strips) that cooperate to form a deformable layer and a layer-firmness changer that includes a strip retainer (e.g., a strip-containment bag) formed to include a strip-storage chamber in which all of the deformable strips are stored and a strip deformer comprising a series of inflatable bladders (e.g., a series of five inflatable bladders)and showing that each bladder is coupled in fluid communication to the pressurized air source and arranged to lie in a bladder-receiving space provided between a pair of adjacent deformable strips;

FIG. 2A is a diagrammatic view showing: (1) NOMINAL compression of elastic material included in the deformable strips as shown in FIG. 3; (2) FIRMER compression of elastic material included in the deformable strips as shown in FIGS. 4; and (3) FIRMEST compression of elastic material included in the deformable strips as shown in FIG. 5;

FIGS. 3-5 show that the firmness of the occupant-support base can be increased, as measured by a firmness sensor such as an Indentation Force Deflection (IFD) Tester at the option of a seat occupant, by admitting pressurized air from the pressurized air source into the inflatable bladders to inflate and expand and stiffen the vertically oriented bladders so as to deform the neighboring strips stored in the strip-storage chamber formed in the strip retainer and thereby increase the firmness of the cushion included in the pad;

FIG. 3 is a sectional view taken along line 3-3 of FIG. 1 showing that the cushion includes a series of deformable strips aligned in side-by-side relation to define a deformable layer and located in a strip-containment bag that serves as the strip retainer and that one inflatable bladder is located in a bladder-receiving space formed between each pair of neighboring deformable strips in the deformable layer and showing that the cushion has a first firmness (F₁), as measured by a firmness sensor such as an Indentation Force Deflection (IFD) tester, when each bladder in the series of inflatable bladders is in an un-inflated state and is maintained at atmospheric pressure (P_{ATM});

FIG. 4 is a sectional view similar to FIG. 2 showing a semi-inflated state of each bladder in the series of inflatable bladders in which pressurized air at a first elevated air pressure (P₁) has been discharged from the pressurized air source into each of the inflatable bladders causing the cushion to have a relatively greater second firmness (F₂) as measured by the IFD tester;

FIG. 5 is a sectional view similar to FIG. 3 showing a fully-inflated state of the inflatable bladders in which pressurized air at a relatively greater second elevated air pressure (P₂) has been admitted into each of the inflatable bladders causing the cushion to have a relatively greater third firmness (F₃) as measured by the IFD tester;

FIG. 6 is an enlarged top plan view of the pressurized pad shown in FIG. 5 with a portion of a top sheet included in strip retainer (e.g., strip-containment bag) broken away to show the deformable strips included in the variable-firmness cushion and with portions of those deformable strips broken away to show the inflated and expanded inflatable bladders deployed in that section of the cushion and filled with pressurized air at second air pressure P₂ to cause the variable-firmness cushion to have a relatively firm third firmness (F₃);

FIGS. 7-10 provide a series of views showing a measurement process in accordance with the present disclosure for measuring Indentation Force Deflection (IFD) using an IFD tester on the pad of FIGS. 1-6 when the inflatable bladders are in their un-inflated states as shown in FIGS. 7 and 8 and in their inflated states as shown in FIGS. 9 and 10;

FIG. 7 is a perspective view of the pad of FIGS. 1-6, with portions broken away, showing that the inflatable bladders included in the cushion are in their un-inflated states and that the IFD tester has measured the first firmness (F₁) as a result of the inflatable bladders being maintained at atmospheric pressure (P_{ATM}) as shown in FIG. 8;

FIG. 8 is a sectional view taken along line 8-8 of FIG. 7 (omitting the cushion cover) showing that during IFD testing, the IFD tester applies a first force (F₁) necessary to deform some of the deformable strips and inflatable bladders to about 75% of the original depth when the inflatable bladders are in their un-inflated states;

FIG. 9 is a view similar to FIG. 7, with portions broken away, showing that the inflatable bladders included in the cushion are in their fully inflated states and that the IFD tester has measured the relatively greater third firmness (F₃) as a result of the inflatable bladders being at the relatively greater second elevated pressure (P₂) as shown in FIG. 10;

FIG. 10 is a sectional view taken along line 10-10 of FIG. 9 (omitting the cushion cover) showing that during IFD testing, the IFD tester applies a relatively greater force (F₃) necessary to deform some of the deformable strips and inflatable bladders to about 75% of the original depth when the inflatable bladders are in their fully inflated states;

FIG. 11 is a perspective view of a second embodiment of a pad in accordance with the present disclosure showing that the pad includes a strip retainer embodied as an endless strip-retainer strap that is arranged to extend around a left side, a top side, a right side, and a bottom side of the deformable layer defined by the deformable strips leaving both a front side and an oppositely facing rear side of the deformable layer defined by the group of deformable strips exposed;

FIG. 12 is a sectional view taken along line 12-12 of FIG. 11 showing that the pad includes a series of spaced-apart bladders (e.g., five spaced-apart bladders) wherein each of the bladders is maintained in an un-inflated state;

FIG. 13 is a perspective view of a third embodiment of a pad in accordance with the present disclosure showing that the pad includes a strip retainer embodied as an endless strip-retainer band arranged to extend around the left side, the rear side, the right side, and the front side of the deformable layer defined by the deformable strips leaving both the top side and the bottom side of the deformable layer defined by the group of deformable strips exposed and covering end apertures opening into each of the bladder-receiving spaces;

FIG. 14 is a perspective view of another embodiment of an inflatable bladder in accordance with the present disclosure suggesting that each inflatable bladder includes a first shell and a companion second shell that is arranged to underlie the first shell and that each shell is formed to include a series of spaced-apart ribs that are arranged to extend partly across the width of that shell;

FIG. 15 is a sectional view taken along line 15-15 of FIG. 14 showing that first shell is coupled to the companion second shell along an interface line between the two shells and at each rib in the series of ribs to restrict expansion of the inflatable bladder in response to admission of pressurized air into the inflatable bladder;

FIG. 16 is a perspective view of a fourth embodiment of a pad in accordance with the present disclosure showing that the pad includes the strip retainer embodied as a strip-containment bag and a series of spaced-apart inflatable bladders and suggesting that each inflatable bladder has a triangular cross-sectional shape;

FIG. 17 is a sectional view taken along line 17-17 of FIG. 16 showing that each inflatable bladder included in the series of inflatable bladders has a triangular cross-sectional shape;

FIG. 18 is a top plan view of a fifth embodiment of a pad in accordance with the present disclosure with a portion of a top sheet included in the strip retainer (e.g., strip-containment bag) broken away to reveal that a variable-firmness cushion included in the pad includes a series of deformable strips of varying width and the outer-most inflatable bags (e.g., three outer-most inflatable bags) on each side of the cushion are spaced-apart from one another by a first lateral distance while the inner-most inflatable bags (e.g., four inner-most inflatable bags) are spaced-apart from one another by a relatively larger second lateral distance;

FIG. 19 is a sectional view taken along line 19-19 of FIG. 18 showing that the series of inflatable bladders includes a series of deformable strips (e.g., a series of nine deformable strips) and one bladder is located in a bladder-receiving space formed between each neighboring pair of deformable strips and showing that some deformable strips (e.g., each of the first, second, third, seventh, eighth, and ninth deformable strips) have a relatively narrow first width and that some other deformable strips (e.g., each of the fourth, fifth, and sixth deformable strips) have a relatively wider second width;

FIG. 20 is a perspective view of another embodiment of a vehicle seat in accordance with the present disclosure showing that a sixth embodiment of a pad in which each inflatable bladder in a series of spaced-apart inflatable bladders is arranged to extend laterally from a right-side edge of a seat pan included in the vehicle seat to a left-side edge of the seat pan and suggesting that each inflatable bladder has a cross-sectional shape which varies across a length of the bladder;

FIG. 21 is a sectional view taken along line 21-21 of FIG. 20 showing that one of the inflatable bladders has a first height on each end of the inflatable bladder and that the height of the inflatable bladder decreases towards a relatively smaller second height at a middle of the inflatable bladder to provide the inflatable bladder with a concave top edge; and

FIG. 22 is a perspective view of a vehicle seat showing that the vehicle seat includes another embodiment of an occupant-support base (e.g., seat back) in accordance with the present disclosure including a seat pan mounted on an underlying seat frame and a pad (e.g., cushion) mounted on the underlying seat pan and showing that the pad includes a variable-firmness cushion located inside a cushion cover and coupled to a pressurized air source that can be operated to vary the firmness of the occupant-support base by a passenger seated on the vehicle seat.

### DETAILED DESCRIPTION

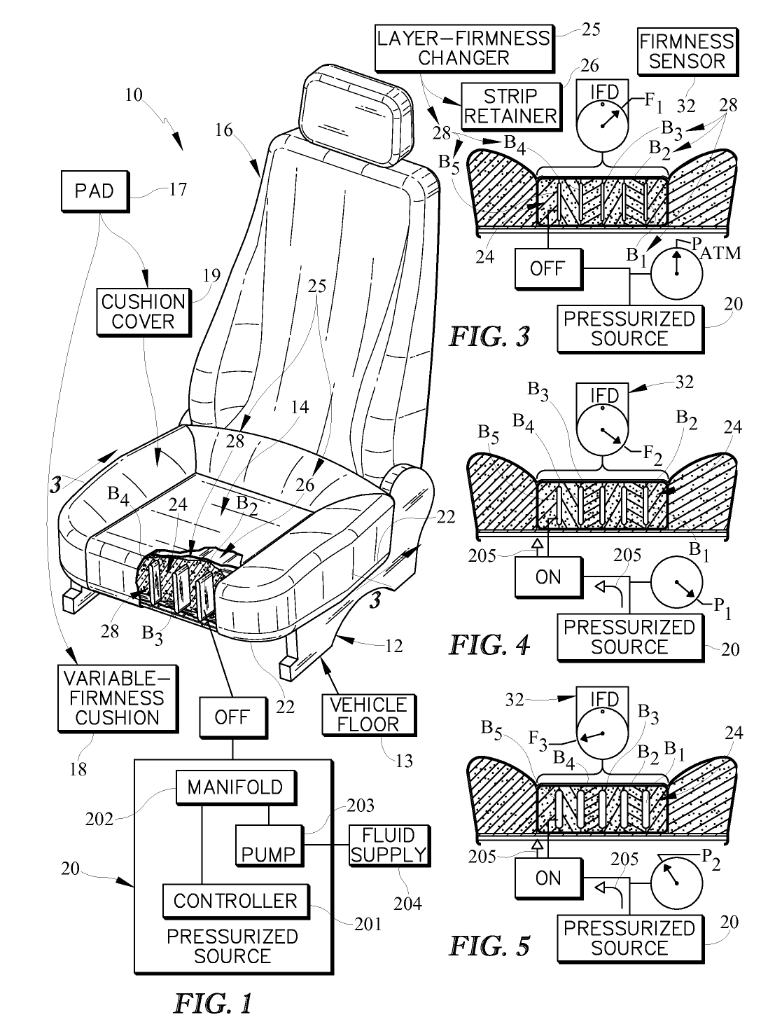

A vehicle seat 10 includes a seat frame 12 adapted to be anchored to a vehicle floor 13, a seat bottom 14 mounted on seat frame 12, and a seat back 16 arranged to extend upwardly from seat bottom 14 as shown in FIG. 1. Seat bottom 14 includes a variable-firmness cushion 18 that is coupled in fluid communication to a pressurized source 20, illustratively a pressurized air source, as suggested in FIGS. 3-5. The pressurized source 20 makes it possible to vary the firmness of variable-firmness cushion 18 under the control of a passenger seated on seat bottom 14.

Seat bottom 14 includes a pad 17 comprising a cushion cover 19 and the variable-firmness cushion 18 in an illustrative embodiment shown in FIG. 1. The pad 17 is mounted on an underlying seat pan 22 that is supported on seat frame 12. Any suitable cushion cover 19 may be used in illustrative embodiments. Variable-firmness cushions 118, 218, 318, 418, and 518 in accordance with other embodiments of the present disclosure are shown, for example, in FIGS. 11-12, 13, 16-17, 18-19, and 20-21.

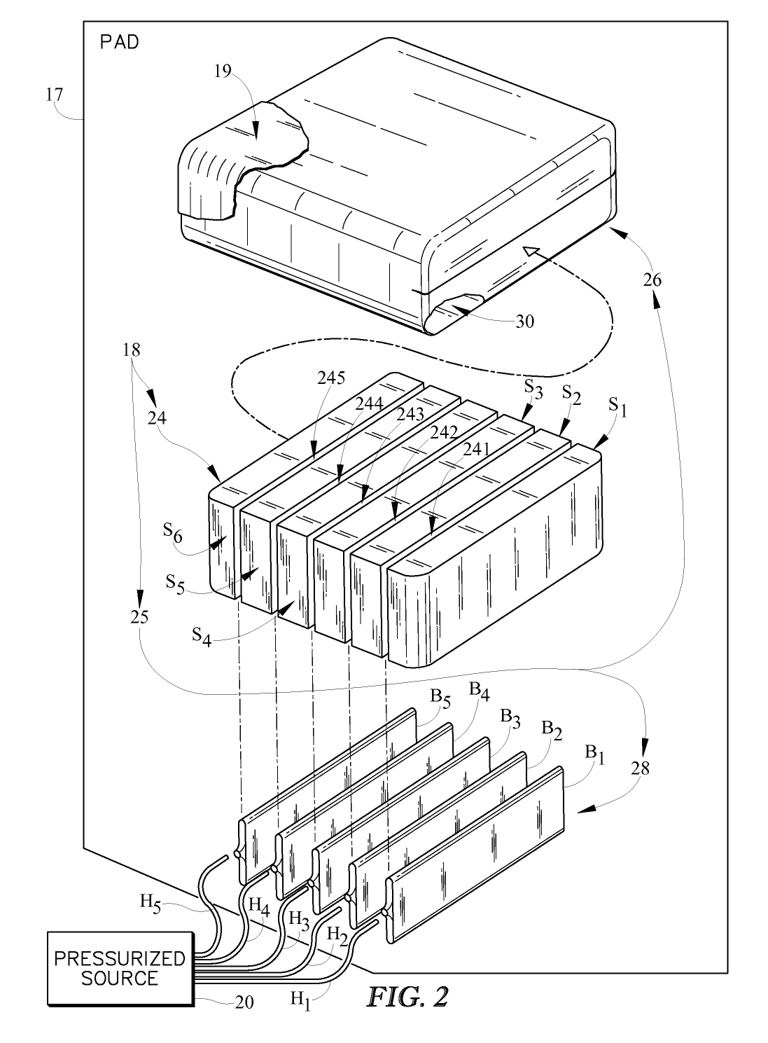

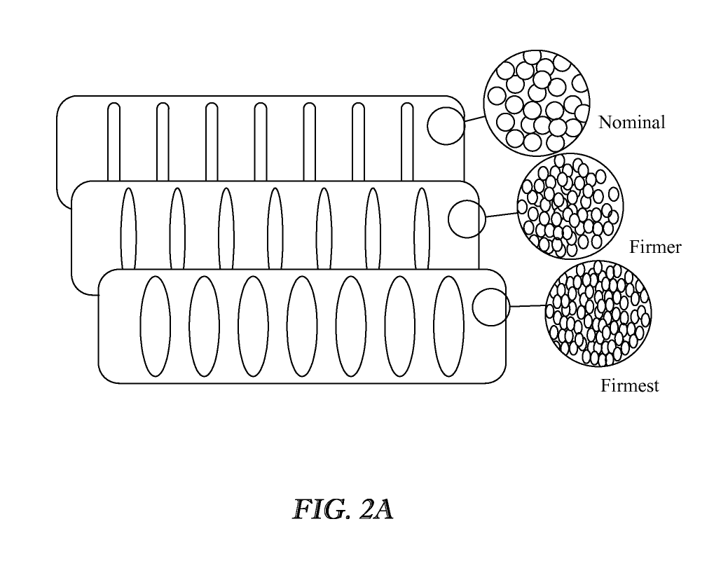

Variable-firmness cushion 18 comprises a deformable layer 24, also called deformable bed 24, comprising several deformable strips (S) arranged to lie in side-by-side relation to one another and a layer-firmness changer 25, also called bed-firmness changer 25, comprising a strip retainer 26 and a strip deformer 28 as shown, for example, in FIG. 2. Strip retainer 26 is, for example, a strip-containment bag formed to include a strip-storage chamber 30 in an illustrative embodiment as shown in FIGS. 1 and 2. Strip deformer 28 includes at least one inflatable bladder (B) that is coupled in fluid communication to the pressurized source 20 and arranged to lie in the deformable layer 24 to position each inflatable bladder (B) in a space provided between two neighboring deformable strips (S) as shown in FIGS. 2-5. In an illustrative embodiment shown in FIG. 2, deformable layer 24 includes six deformable strips S₁-S₆ made of an elastic material and strip deformer 28 includes five inflatable bladders B₁-B₅. In one illustrative example, the elastic material is polyurethane foam.

When the bladders B₁-B₅ of the strip deformer 28 are inflated using any suitable pressurized fluid, such as pressurized air provided by the pressurized source 20, the deformable strips S₁-S₆ held in the strip-storage chamber 30 formed in the strip retainer 26 are compressed to increase the firmness of the deformable layer 24 and therefore increase the firmness of the variable-firmness cushion 18 as shown in FIGS. 3-5. In contrast, when the bladders B₁-B₅ of the strip deformer 28 are deflated by discharging pressurized fluid from the bladders B₁-B₅, the deformable strips S₁-S₆ are allowed to expand elastically inside the strip-storage chamber 30 formed in the strip retainer 26 to decrease the firmness of the deformable layer 24 and therefore decrease the firmness of the variable-firmness cushion 18. It is within the scope of the present disclosure to provide variable-firmness cushion 18 with any suitable number of deformable strips (S) and/or inflatable bladders (B).

In an illustrative embodiment suggested in FIG. 1, the pressurized source 20 comprises a controller 201, a manifold 202, and a pump 203 (e.g., an air pump 203.) The controller 201 is used by a vehicle passenger (not shown) to actuate the manifold 202 to direct the pump 203 coupled to a fluid supply 204 to generate a pressurized fluid stream 205 (e.g., a pressurized air stream 205). The pressurized fluid stream 205 is directed through a series of hoses H₁-H₅ wherein each hose (H) is coupled to one of the inflatable bladders B₁-B₅ included in strip deformer 28 as shown in FIG. 2. This pressurized fluid stream 205 causes each inflatable bladder (B) to expand outwardly in a space provided between a neighboring pair of deformable strips (S) to assume a partly or fully inflated state as shown in FIGS. 4 and 5. It is within the scope of the present disclosure to use any suitable fluid pressure management system to inflate and deflate the inflatable bladders B₁-B₅ under the command of a vehicle passenger or other bladder operator. It is also within the scope of the present disclosure to have one hose (H) which is coupled to at least two inflatable bladders (B) included in the strip deformer 28. It is also within the scope of the present disclosure have to each inflatable bladder (B) inflated to a different pressure from every other inflatable bladder (B).

The deformable layer 24 includes six deformable strips S₁-S₆ made of a deformable material (e.g., a deformable elastic material) in an illustrative embodiment as shown, for example, in FIG. 2:
a first inflatable bladder B₁ is positioned to lie in a space 241 provided between adjacent strips S₁, S₂ and is coupled to first hose H₁,
a second inflatable bladder B₂ is positioned to lie in a space 242 provided between adjacent strips S₂, S₃ and is coupled to second hose H₂,
a third inflatable bladder B₃ is positioned to lie in a space 243 provided between adjacent strips S₃, S₄ and is coupled to third hose H₃,
a fourth inflatable bladder B₄ is positioned to lie in a space 244 provided between adjacent strips S₄, S₅ and coupled to fourth hose H₄, and
a fifth inflatable bladder B₅ is positioned to lie in a space 245 provided between adjacent strips S₅, S₆ and is coupled to fifth hose H₅,
   An opposite end of each hose H₁-H₅ is coupled to the pressurized source 20 so that pressurized fluid stream 205 can flow from the pressurized source 20 to each of the inflatable bladders B₁-B₅ through an appropriate hose (H) under the control of a seat passenger or other controller.

It is within the scope of the present disclosure to vary the number, size, and shape of the bladder-receiving spaces provided between adjacent pairs of deformable strips (S). In addition, it is also within the scope of the present disclosure to vary the number, size, and shape of the deformable strips (S) and/or the inflatable bladders B. It is also within the scope of the present disclosure to vary the materials used to form each deformable strip (S).

In the illustrated embodiments, each deformable strip (S) is a discrete element unconnected to neighboring strips (S) to cause the bladder-receiving space between each adjacent pair of deformable strips (S) to extend fully across the vertical thickness of the deformable layer 24 defined by the deformable strips (S). It is within the scope of this disclosure to link neighboring deformable strips (S) to one another to cause the bladder-receiving spaces between adjacent pairs of deformable strips (S) to be top-opening, bottom-opening, and/or side-opening pockets or slits. In another example, the deformable layer may include a one-piece or monolithic part made of a deformable material in which a series of deformable strips are formed therein.

The firmness of variable-firmness cushion 18 can be increased as measured by a firmness sensor 32 such as an Indentation Force Deflection (IFD) tester at the option of a seat occupant by admitting pressurized fluid stream 205 from the pressurized source 20 into the inflatable bladders (B) to inflate and expand the bladders (B) so as to deform the neighboring deformable strips (S) stored in the strip-storage chamber 30 formed in the strip retainer 26 and thereby increase the firmness of the variable-firmness cushion 18 included in the pad 17 as shown in FIGS. 3-5. The firmness sensor 32 may also be used to detect a decreasing firmness of the variable-firmness cushion 18 as a result of discharge of pressurized fluid from the inflatable bladders (B).

As shown in FIG. 3, the variable-firmness cushion 18 includes a series of deformable strips (S) aligned in side-by-side relation to define the deformable layer 24 and an inflatable bladder (B) is located in a bladder-receiving space formed between each pair of neighboring deformable strips (S) in the deformable layer 24. The variable-firmness cushion 18 has a first firmness F₁ as measured by an Indentation Force Deflection (IFD) tester 32 when each bladder B₁-B₅ in the series of inflatable bladders (B) is in an un-inflated state and is maintained at atmospheric pressure P_{ATM}.

As suggested in FIG. 4, a semi-inflated state of each bladder B₁-B₅ in the series of inflatable bladders (B) is illustrated in which the pressurized fluid stream 205 at a first elevated fluid pressure P₁ has been discharged from the pressurized source 20 into each of the inflatable bladders (B) causing the variable-firmness cushion 18 to have a relatively greater second firmness F₂ as measured by the IFD tester 32. As shown in FIG. 5, a fully-inflated state of the inflatable bladders (B) is illustrated in which the pressurized fluid stream 205 at a relatively greater second elevated fluid pressure P₂ has been admitted into each of the inflatable bladders (B) causing the variable-firmness cushion 18 to have a relatively greater third firmness F₃ as measured by the IFD tester 32. In one illustrative example, the relatively greater second elevated fluid pressure P₂ is about 14.5 PSI (1 Bar).

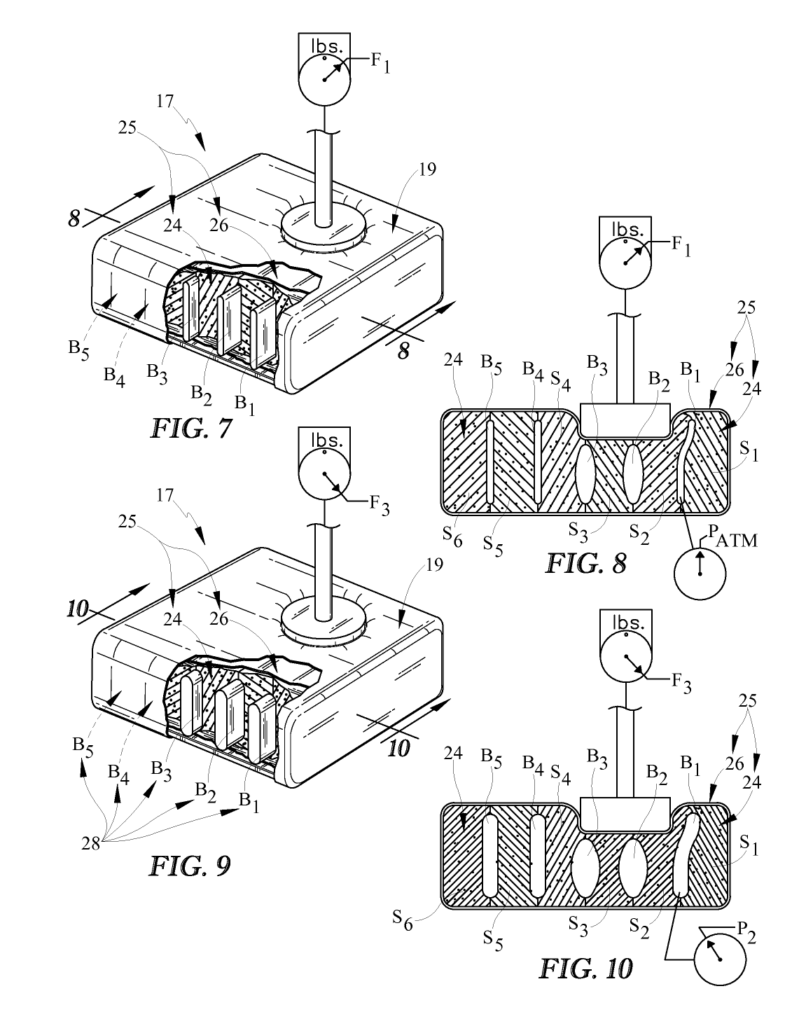

A measurement process for measuring the Indentation Force Deflection (IFD) using the IFD tester 32 on the pad 17 is shown in FIGS. 7-10. The inflatable bladders (B) are shown in their un-inflated states as shown in FIGS. 7 and 8 and in their inflated states as shown in FIGS. 9 and 10.

A perspective view of pad 17, with portions broken away, is provided in FIG. 7 to show that the bladders B₁-B₅ in their un-inflated states and that the IFD tester 32 has measured the first firmness F₁ as a result of the inflatable bladders B₁-B₅ being in the un-inflated state (e.g., at atmospheric pressure P_{ATM}.) During IFD testing, the IFD tester 32 applies a first force F₁ necessary to deform some of the deformable strips (S) and the inflatable bladders (B) to about 75% of the original depth when the inflatable bladders (B) are in their un-deflated states as shown in FIG. 8. The inflatable bladders (B) included in the variable-firmness cushion 18 are in their fully inflated states as shown in FIG. 9. The IFD tester 32 has measured the relatively greater third firmness F₃ as a result of the inflatable bladders (B) being at the relatively greater second elevated pressure P₂. The IFD tester 32 applies a relatively greater force F₃ necessary to deform some of the deformable strips (S) and the inflatable bladders (B) to about 75% of the original depth when the inflatable bladders (B) are in their fully inflated states as suggested in FIG. 10.

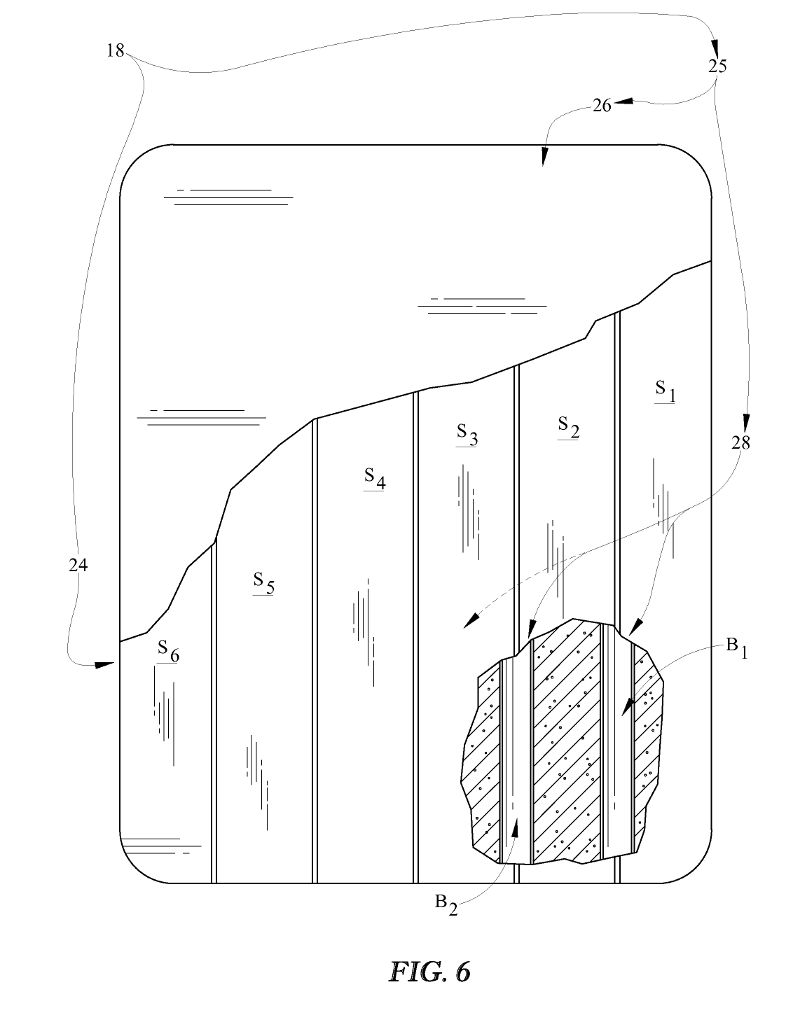

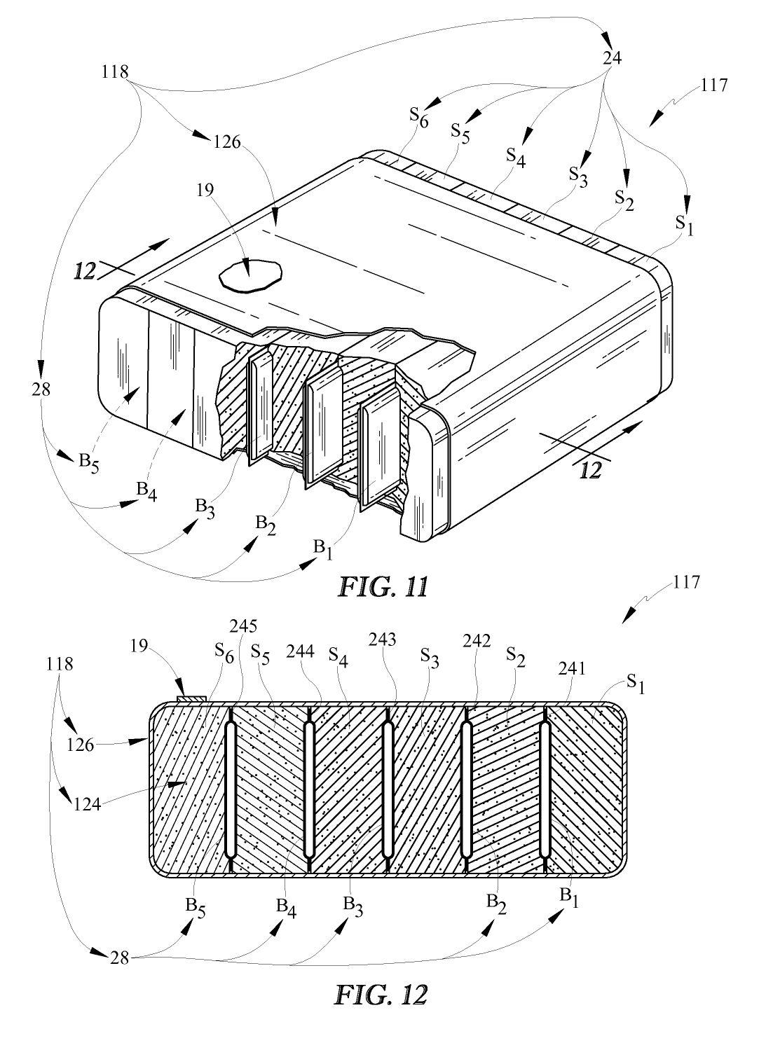

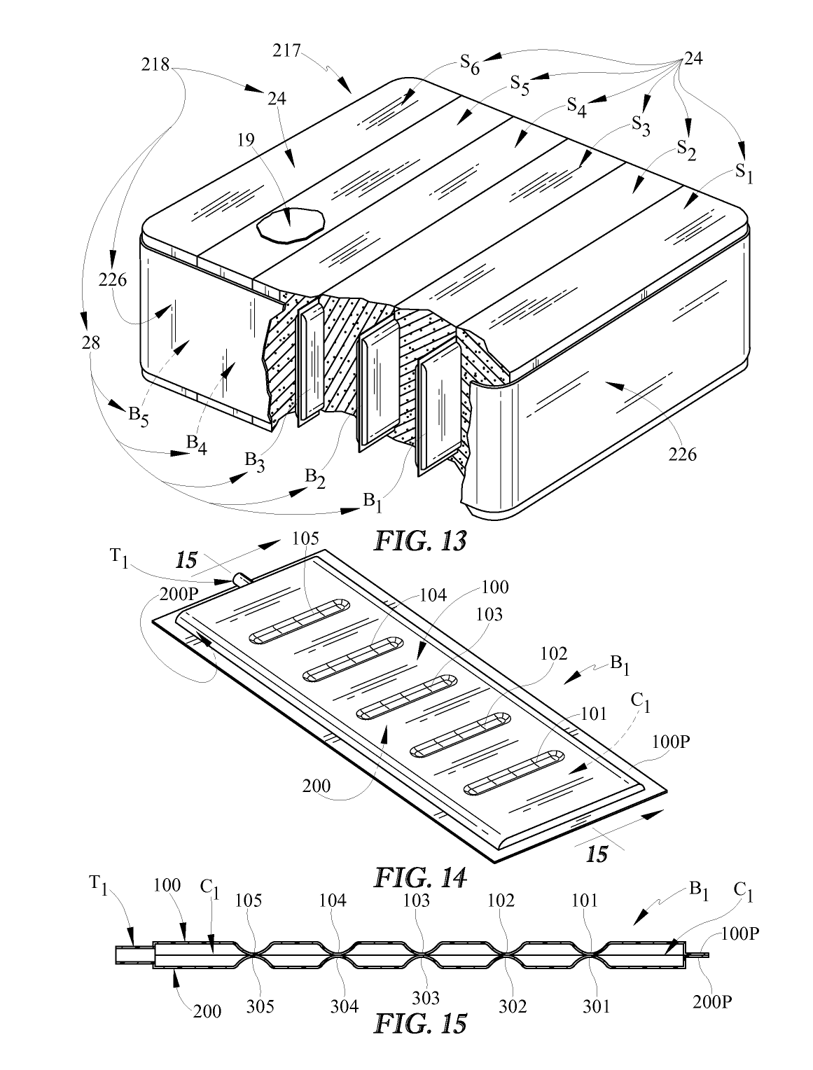

Several strip-retainer means for retaining the deformable strips (S) cooperating to define the deformable layer 24 included in the variable-firmness cushion 18 are disclosed herein in accordance with the present disclosure. These strip-retainer means include, for example, a strip-containment bag 26 as shown in FIGS. 2, 6, 7, 9, and 16-21, an endless strip-retainer strap 126 wrapped around the left, top, right, and bottom sides of the deformable layer 24 and included in a pad 117 as shown in FIGS. 11 and 12, and an endless strip-retainer band 226 wrapped around the left, rear, right, and front sides of the deformable layer 24 and included in a pad 217 as shown in FIG. 13. In one illustrative example, the strip-containment bag 26, the strip-retainer strap 126, and the strip-retainer band 226 are made from a tight-knit material (e.g., cloth) that has little or no stretch.

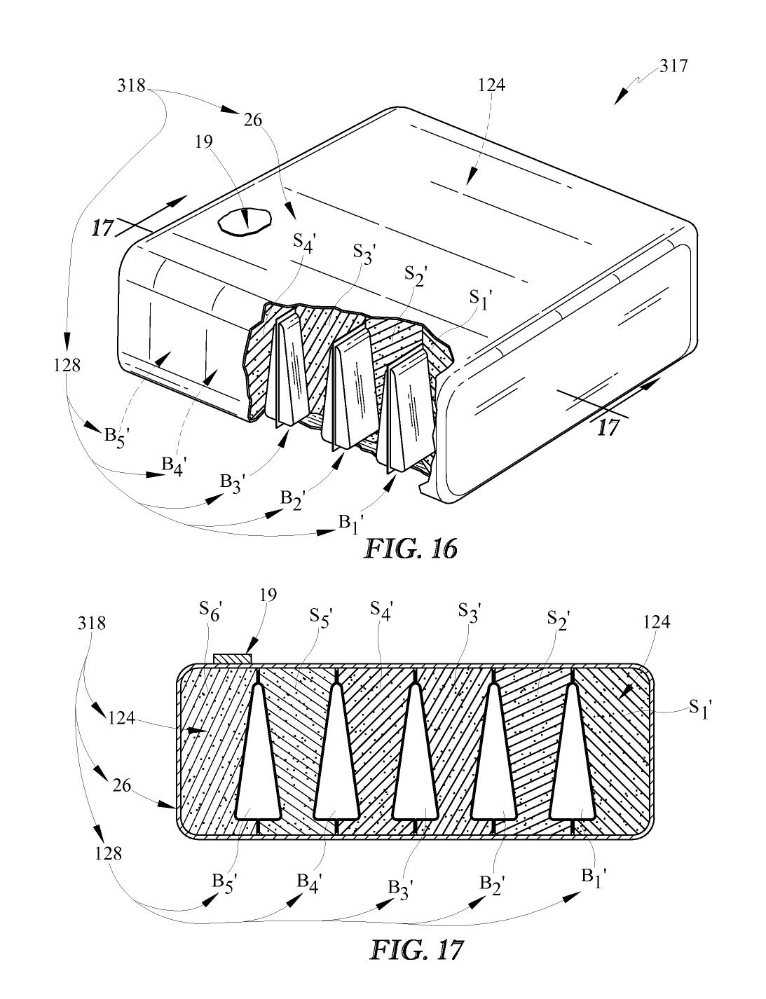

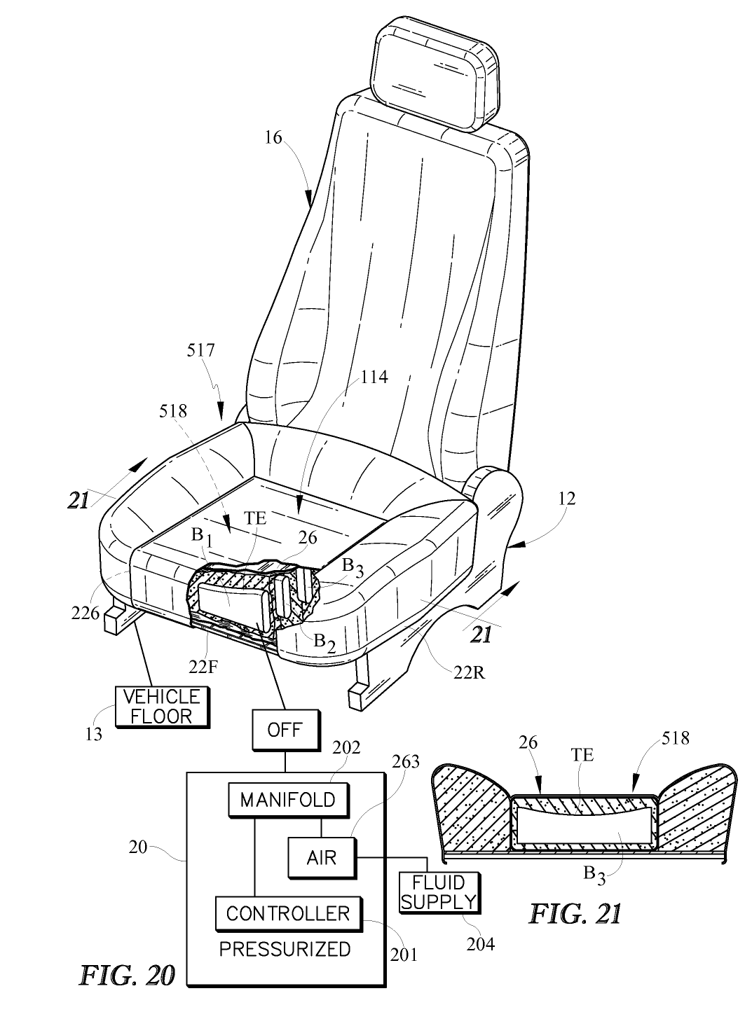

Inflatable bladders (S) in accordance with the present disclosure can take several forms:
a bladder B₁ in accordance with a first embodiment of the present disclosure is shown in FIG. 2,
a bladder B₁′ having a triangular cross-sectional shape in accordance with a second embodiment of the present disclosure is shown in FIGS. 14 and 15,
a bladder B₁″ in accordance with a third embodiment of the present disclosure is shown in FIGS. 16 and 17,
a bladder B₁′″ having a non-uniform vertical height and a concave top edge in accordance with a fourth embodiment of the present disclosure is shown in FIGS. 20 and 21, or
a bladder of any suitable size or shape.

As suggested in FIGS. 14 and 15, the inflatable bladder B₁ includes a top shell 100 coupled to a bottom shell 200 along perimeter edges 100P, 200P thereof to form an interior fluid-receiving chamber C₁ therein. The top shell 100 includes a series of laterally extending and downwardly projecting ribs 101, 102, 103, 104, and 105. The bottom shell 200 includes a series of laterally extending and upwardly projecting ribs 301, 302, 303, 304, 305. As shown in FIG. 15, companion pairs of ribs (101, 301), (102, 302), (103, 303), (104, 304), and (105, 305) mate to rigidify the inflatable bladder B₁. The top and bottom shells 100, 200 cooperate to form a fluid-admission tube T₁ adapted to be coupled in fluid communication to the hose H₁. In one example, the top and bottom shells 100, 200 are made of pliable materials to allow bladder B₁ to expand when inflated and contract when deflated. The pliable materials, may be for example, Thermoplastic Polyurethane (TPU).

As suggested in FIGS. 16 and 17, each inflatable bladder (B) has a triangular cross-sectional shape. In this embodiment, the strip deformer 128 includes five inflatable bladders B₁′, B₂′, B₃′, B₄′, and B₅′. The deformable strips S₁′, S₂′, S₃′, S₄′, S₅′, and S₆′ are configured to mate with and surround the triangle-shaped inflatable bladders (B).

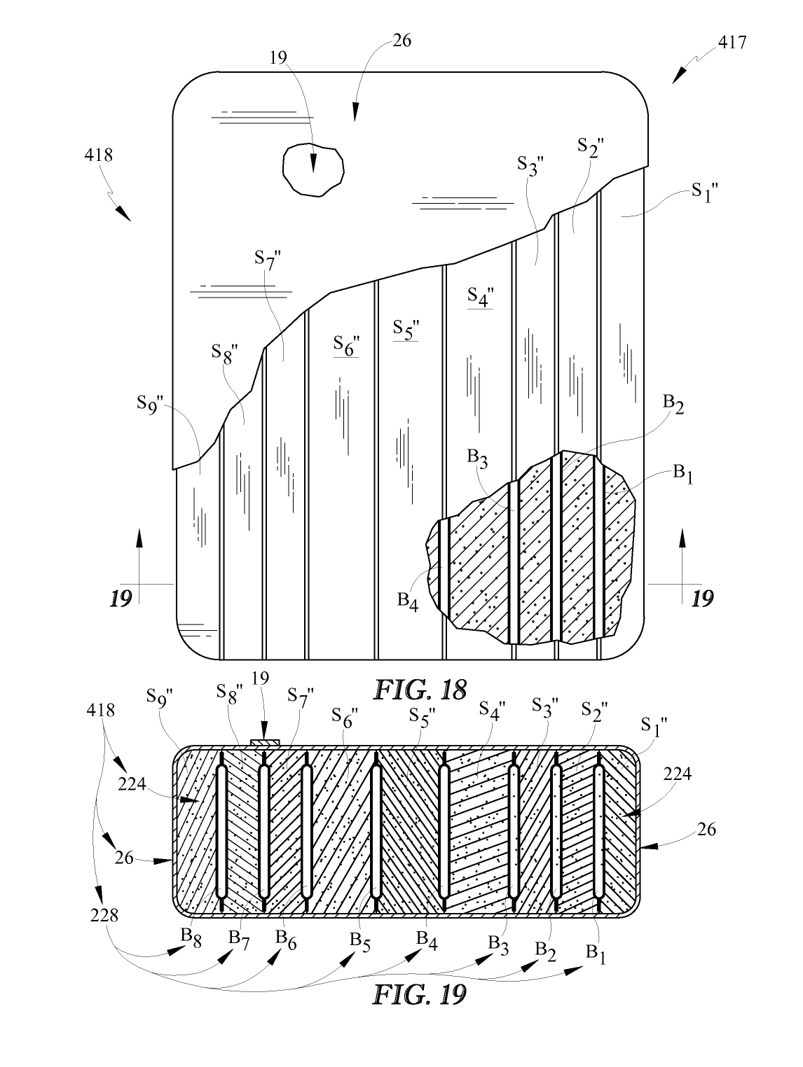

As suggested in FIGS. 18 and 19, a strip deformer 228 includes eight inflatable bladders B₁-B₈, six narrow-width deformable strips S₁″, S₂″, S₃″, S₆″, S₇″, and S₈″, and three wide-width deformable strips S₄″, S₅″, and S₆″. As shown best in FIG. 19, there is a wide lateral spacing between bladders B₃, B₄, B₅, and B₆ and a relatively narrow lateral spacing between the bladders in a set of right-side bladders B₁, B₂, and B₃ and in a set of left-side bladders B₆, B₇, and B₈.

The variable-firmness cushion 18 can be configured in accordance with the present disclosure to be used in many kinds of vehicles such as cars, trucks, buses, trains, airplanes, ferries, etc. The variable-firmness cushion 18 is constructed to have an adjustable firmness that is controllable by a vehicle occupant or other operator. Deformable strips (S) and inflatable bladders (B) cooperate to provide a cushion that is not stiff and compressed if an occupant shifts to a low-sinking position in the vehicle seat including the cushion.

In accordance with the present disclosure, inflation and deflation of the inflatable bladders (B) can be regulated by operation of the pressurized source 20 to vary the effective firmness of the deformable strips (S) and thus the firmness of the deformable layer 24 included in the variable-firmness cushion of the pad 17. The inflatable bladders (B) are arranged in patterns in accordance with the present disclosure to provide comfortable firmness variations to passengers seated on a seat including the variable-firmness cushion 18. These inflatable bladders (B) can be inflated and deflated while the deformable strips (S) are retained in a predetermined arrangement (e.g., in side-by-side relation to one another) by means of a strip retainer of, for example, the types disclosed herein to, in effect, change the firmness of the deformable strips (S) at the direction of a passenger seated on a seat including the variable-firmness cushion 18. In accordance with the illustrative embodiments of the present disclosure, the deformable strips (S) are constrained to remain in a predetermined alignment by the strip retainer 26 and are also squeezed physically, illustratively pneumatically, generated external forces created by the inflatable bladders (B) while constrained by the strip retainer 26.

In use, the inflatable bladders (B) operate independently of one another to apply external strip-squeezing forces to the neighboring deformable strips (S) that are constrained by the strip retainer 26 and alternatively by the other strip retainers disclosed herein. Unnatural negative pressure displacement (NPD) is avoided when passengers are seated on the variable-firmness cushion 18 because downward pressure applied by a seated passenger acts to compress one or more of the deformable strips (S) and the inflatable bladders (B) without forcing any portion of the variable-firmness cushion 18 upwardly away from the underlying seat pan 22 to an elevation above the elevation of an unoccupied variable-firmness cushion 18.

When the pressurized fluid stream 205 is discharged from the pressurized source 20 through the hoses (H) into the inflatable bladders B, the bladders (B) expand and compress the deformable strips (S) retained in the strip-containment bag 26. Firmness is generated in illustrative embodiments by two factors:
(1) the compression of the deformable strips (S), illustratively in the strip-containment bag 26 and
(2) the vertical stiffness of the inflatable bladders (B) once the inflated bladders (B) are inflated.
   No vacuum is needed to adjust firmness of the variable-firmness cushion 18 in accordance with the present disclosure. The cushion firmness is dissipated and the variable-firmness cushion 18 returns to a nominal firmness in accordance with the present disclosure by opening a discharge valve provided in the pressurized source 20 and the weight of the occupant that is applied downwardly onto the top of the variable-firmness cushion 18.

The vehicle seat 10 includes deformable layer 24 and layer-firmness changer 25 as shown, for example, in FIGS. 1-3. Deformable layer 24 includes a series of deformable strips (S), illustratively made of elastic material, and arranged to lie in side-by-side relation to one another. Layer-firmness changer 25 includes strip deformer 28 comprising several inflatable bladders (B). Each inflatable bladder (B) is positioned to lie in a bladder-receiving space provided between a companion pair of adjacent deformable strips (S) included in deformable layer 24 and adapted to be coupled in fluid communication to a pressurized source 20. The layer-firmness changer 25 also includes the strip retainer 26 configured to provide means for retaining the series of deformable strips (S) in side-by-side relation to one another during deformation of the deformable strips (S) caused:
in one instance by inflation of each inflatable bladder (B) using the pressurized fluid stream 205 from the pressurized source 20 and a resulting expansion in size of each of the inflatable bladders (B) and
in another instance by deflation of each inflatable bladder (B) to discharge the pressurized fluid to the pressurized source 20 and a resulting contraction in size of each of the inflatable bladders (B)
   so that firmness of the deformable layer 24 is increased in response to inflation of the inflatable bladders (B) and is decreased in response to deflation of the inflatable bladders B.

Deformable layer 24 and layer-firmness changer 25 cooperate to form variable-firmness cushion 18 included in the seat bottom 14. Vehicle seat 10 includes the seat pan 22 underlying and supporting seat bottom 14 and seat back 16 extending upwardly from seat bottom 14 as suggested in FIG. 1.

Deformable layer 24 may include six deformable strips S₁-S₆ as shown in FIG. 2. Each deformable strip (S) includes a rear end positioned to lie on a rear portion of the seat pan 22 adjacent to a lower portion of the seat back 16 and an opposite front end positioned to lie on a front portion of the seat pan 22 in spaced-apart relation to the seat back 16. Each bladder-receiving space is arranged to extend in a direction away from the seat back 16 between the rear and front portions of the seat pan 22 as shown in FIGS. 1 and 2.

A first inflatable bladder B₁ is located in a first bladder-receiving space 241 provided between a first and a second of the deformable strips S₁, S₂ as suggested in FIG. 2. A second inflatable bladder B2 is located in a second bladder-receiving space 242 provided between the second and a third of the deformable strips S₂, S₃. A third inflatable bladder B₃ is located in a third bladder-receiving space 243 provided between the third and a fourth of the deformable strips S₃, S₄. A fourth inflatable bladder B4 is located in a fourth bladder-receiving space 244 provided between the fourth and a fifth of the deformable strips S₄, S₅. A fifth inflatable bladder B5 is located in a fifth bladder-receiving space 245 provided between the fifth and a sixth of the deformable strips S₅, S₆.

At least one of the inflatable bladders (B) has a triangular cross-sectional shape in a pad 317 as suggested in an embodiment shown in FIGS. 16 and 17. The triangular cross-sectional shape may be isosceles. Accordingly, a base of the isosceles-shaped inflatable bladder (B) may be located in close proximity to the seat pan 22 and a tip of the isosceles-shaped inflatable bladder (B) may be arranged to lie in spaced-apart relation to the seat pan 22 to extend away therefrom.

In the embodiment of FIGS. 18 and 19, the deformable layer 224 in a pad 417 may include nine deformable strips S₁″-S₉″. Each deformable strip (S) includes a rear end positioned to lie on a rear portion of the seat pan 22 adjacent to a lower portion of the seat back 16 and an opposite front end positioned to lie on the front portion of the seat pan 22 in spaced-apart relation to the seat back 16. Each bladder-receiving space is arranged to extend in a direction away from the seat back 16 between the rear and front portions of the seat pan 22. Each of the first, second, third, seventh, eighth, and ninth deformable strips have a first width. Each of the fourth, fifth, and sixth deformable strips have a relatively wider second width. The inflatable bladders B₁-B₈ are arranged to lie in series in spaced-apart relation to one another to provide:
a first lateral distance, illustratively a generally uniform first lateral distance, between each of the first and second inflatable bladders B₁, B₂, the second and third inflatable bladders B₂, B₃, the sixth and seventh inflatable bladders B₆, B₇, and the seventh and eighth inflatable bladders B₇, B₈ and
a second lateral distance, illustratively a relatively larger and generally uniform second lateral distance, between each of the third and fourth inflatable bladders B₃, B₄, the fourth and fifth inflatable bladders B₄, B₅, and the fifth and sixth inflatable bladders B₅, B₆.

In the embodiment of FIGS. 20-21, the seat pan 22 includes:
a front edge 22F,
a left-side edge 22L that extends toward the front edge 22F in a direction away from the seat back 16, and
a right-side edge 22R that extends toward the front edge 22F in a direction away from the seat back 16 and lies in laterally spaced-apart relation to the left-side edge 22L.
   Each inflatable bladder (B) is arranged to extend laterally from the right-side edge 22R of seat pan 22 to the left-side edge 22L of seat pan 22. In illustrative embodiments, each inflatable bladder (B) has a cross-sectional shape that varies along the length thereof. Each inflatable bladder (B) includes a concave top edge TE arranged to face upwardly away from the underlying seat pan 16.

In illustrative embodiments, seat bottom 14 is a pad 17 that includes variable-firmness cushion 18 and a cushion cover 19 formed to include a cushion-receiving chamber containing variable-firmness cushion 18 therein as suggested in FIGS. 1 and 2. Strip retainer 26 is a strip-containment bag formed to include strip-storage chamber 30 containing deformable strips (S) and inflatable bladders B. Strip-containment bag 26 is located in cushion-receiving chamber of cushion cover 19 as shown in FIGS. 1 and 2.

In the embodiment of FIGS. 11 and 12, the strip retainer is an endless strip-retainer strap 126 that is arranged to extend in sequence around a left side, a top side, a right side, and a bottom side of the deformable layer 24. The bottom side faces downwardly toward the seat pan 22. The top side faces upwardly away from the seat pan 22.

In the embodiment of FIG. 13, the strip retainer is an endless strip-retainer band 226 that is arranged to extend in sequence around a left side, a rear side, a right side, and a front side of the deformable layer 24. A bottom side of the deformable layer 24 faces downwardly toward the seat pan 22 and a top side of the deformable layer 24 faces upwardly away from the seat pan 22.

The present disclosure is not limited to the above described illustrative embodiments. It is within the scope of the present disclosure to combine the above described illustrative embodiments. Particularly, the seat cushion according to the present disclosure may comprise bladders and/or deformable strips having different shapes (straight, triangular, etc.) and/or different sizes within the same deformable layer.

The present disclosure also relates to a seat cushion in which deformable strips are made in a block of seat foam and inflatable bladders being slotted in the seat foam. As a result, the strip retainer may be omitted.

The present disclosure has been provided with regard to a seat cushion. The seat cushion may be used as part of a seat bottom and/or a seat back. The seat cushion when used in the seat back includes a deformable layer including a series of deformable strips arranged to lie in side-by-side relation to one another and a layer-firmness changer including a strip deformer comprising several inflatable bladders positioned to lie in a bladder-receiving space provided between a pair of adjacent deformable strips.

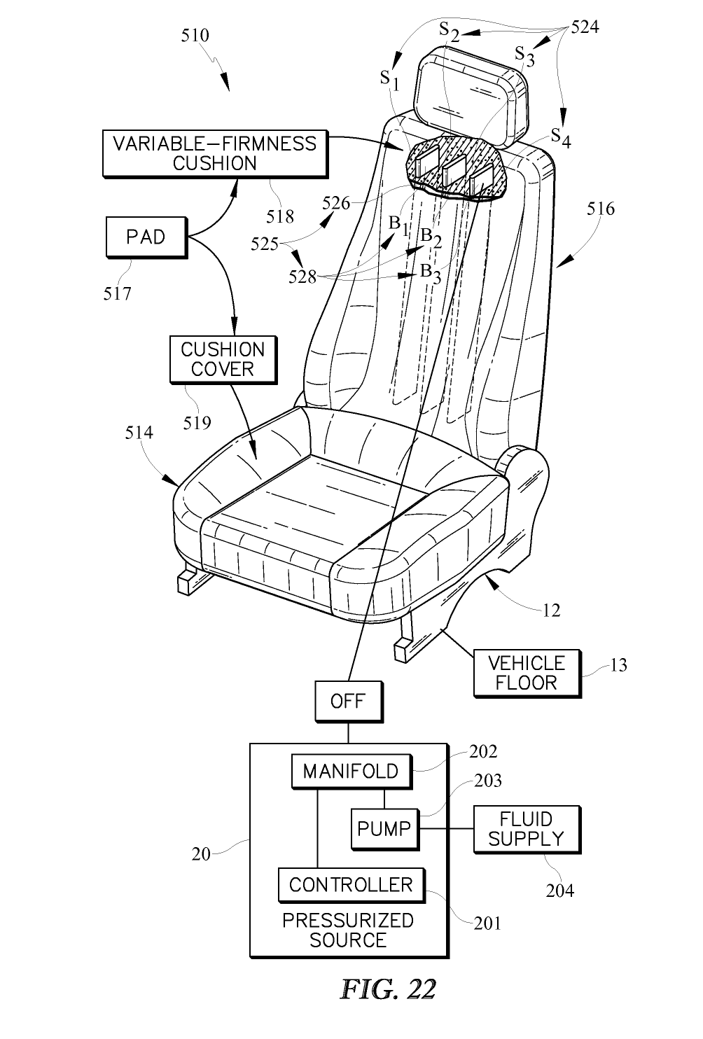

A vehicle seat 510 includes seat frame 12 adapted to be anchored to a vehicle floor 13, a seat bottom 514 mounted on seat frame 12, and a seat back 516 arranged to extend upwardly from seat bottom 514 as shown in FIG. 22. Seat back 516 includes a variable-firmness cushion 518 that is coupled in fluid communication to pressurized source 20, illustratively a pressurized air source, as suggested in FIG. 22. The pressurized source 20 makes it possible to vary the firmness of variable-firmness cushion 518 under the control of a passenger resting against seat back 516.

Seat back 516 includes a pad 517 comprising a cushion cover 519 and the variable-firmness cushion 518 in an illustrative embodiment shown in FIG. 22. The pad 517 is mounted on an underlying seat pan that is supported on seat frame 12. Any suitable cushion cover 519 may be used in illustrative embodiments.

Variable-firmness cushion 518 comprises a deformable layer 524, also called deformable bed 524, comprising several deformable strips (S) arranged to lie in side-by-side relation to one another and a layer-firmness changer 525, also called bed-firmness changer 525, comprising a strip retainer 526 and a strip deformer 528 as suggested in FIG. 2. Strip retainer 526 is, for example, a strip-containment bag 526 formed to include a strip-storage chamber in an illustrative embodiment as shown in FIGS. 1 and 2. Strip deformer 528 includes at least one inflatable bladder (B) that is coupled in fluid communication to the pressurized source 20 and arranged to lie in the deformable layer 524 to position each inflatable bladder (B) in a space provided between two neighboring deformable strips (S). In an illustrative embodiment shown in FIG. 2 2, deformable layer 524 includes several deformable strips S₁-S₄ made of an elastic material and strip deformer includes several inflatable bladders B₁-B₃. In one illustrative example, the elastic material is polyurethane foam.

When the bladders B₁-B₃ of the strip deformer 528 are inflated using any suitable pressurized fluid, such as pressurized air provided by the pressurized source 20, the deformable strips S₁-S₄ held in the strip-storage chamber formed in the strip retainer 526 are compressed to increase the firmness of the deformable layer 524 and therefore increase the firmness of the variable-firmness cushion 518. In contrast, when the bladders B₁-B₃ of the strip deformer 528 are deflated by discharging pressurized fluid from the bladders B₁-B₃, the deformable strips S₁-S₄ are allowed to expand elastically inside the strip-storage chamber formed in the strip retainer 526 to decrease the firmness of the deformable layer 524 and therefore decrease the firmness of the variable-firmness cushion 518. It is within the scope of the present disclosure to provide variable-firmness cushion 18 with any suitable number of deformable strips (S) and/or inflatable bladders (B).

The following numbered clauses include embodiments that are contemplated and non-limiting:

Clause 1. A vehicle seat comprising
a deformable layer including a series of deformable strips made of elastic material and arranged to lie in side-by-side relation to one another and
a layer-firmness changer including a strip deformer comprising at least one inflatable bladder, the inflatable bladder being positioned to lie in a bladder-receiving space provided between a pair of adjacent deformable strips included in the deformable layer and adapted to be coupled in fluid communication to a pressurized source.

Clause 2. A vehicle seat comprising
a deformable elastic bed including a series of deformable strips made of elastic material and arranged to lie in side-by-side relation to one another and
a bed-firmness changer including a strip deformer comprising several inflatable bladders, each inflatable bladder being positioned to lie in a bladder-receiving space provided between a companion pair of adjacent deformable strips included in the deformable elastic bed and adapted to be coupled in fluid communication to a pressurized fluid source to cause the deformable strips to deform in one instance in response to inflation of each inflatable bladder using pressurized fluid from the pressurized fluid source and a resulting expansion in size of each of the inflatable bladders and in another instance by deflation of each inflatable bladder to discharge pressurized fluid to the pressurized fluid source and a resulting contraction in size of each of the inflatable bladders so that firmness of the deformable elastic bed is increased in response to inflation of the inflatable bladders and is decreased in response to deflation of the inflatable bladders.

Clause 3. A vehicle seat comprising
a deformable elastic bed including a series of deformable strips made of elastic material and arranged to lie in side-by-side relation to one another and
a bed-firmness changer including a strip deformer comprising several inflatable bladders, each inflatable bladder being positioned to lie in a bladder-receiving space provided between a companion pair of adjacent deformable strips included in the deformable elastic bed and adapted to be coupled in fluid communication to a pressurized fluid source and a strip retainer configured to provide means for retaining the series of deformable strips in side-by-side relation to one another during deformation of the deformable strips caused in one instance by inflation of each inflatable bladder using pressurized fluid from the pressurized fluid source and a resulting expansion in size of each of the inflatable bladders and in another instance by deflation of each inflatable bladder to discharge pressurized fluid to the pressurized fluid source and a resulting contraction in size of each of the inflatable bladders so that firmness of the deformable elastic bed is increased in response to inflation of the inflatable bladders and is decreased in response to deflation of the inflatable bladders.

Clause 4. The vehicle seat of claim 1, wherein the deformable elastic bed and the bed-firmness changer cooperate to form a variable-firmness cushion included in a seat bottom and further comprising a seat pan underlying and supporting the seat bottom and a seat back extending upwardly from the seat bottom.

Clause 5. The vehicle seat of any preceding clause, wherein the deformable elastic bed includes six deformable strips, each deformable strip includes a rear end positioned to lie on a rear portion of the seat pan adjacent to a lower portion of the seat back and an opposite front end positioned to lie on a front portion of the seat pan in spaced-apart relation to the seat back, and each bladder-receiving space is arranged to extend in a direction away from the seat back between the rear and front portions of the seat pan.

Clause 6. The vehicle seat of any preceding clause, wherein a first inflatable bladder is located in a first bladder-receiving space provided between a first and a second of the deformable strips, a second inflatable bladder is located in a second bladder-receiving space provided between the second and a third of the deformable strips, a third inflatable bladder is located in a third bladder-receiving space provided between the third and a fourth of the deformable strips, a fourth inflatable bladder is located in a fourth bladder-receiving space provided between the fourth and a fifth of the deformable strips, and a fifth inflatable bladder is located in a fifth bladder-receiving space provided between the fifth and a sixth of the deformable strips.

Clause 7. The vehicle seat of any preceding clause, wherein at least one of the inflatable bladders has a triangular cross-sectional shape.

Clause 8. The vehicle seat of any preceding clause, wherein the triangular cross-sectional shape is isosceles and a base of the isosceles-shaped inflatable bladder is located in close proximity to the seat pan and a tip of the isosceles-shaped inflatable bladder is arranged to lie in spaced-apart relation to the seat pan to extend away therefrom.

Clause 9. The vehicle seat of any preceding clause, wherein the deformable elastic bed includes nine deformable strips, each deformable strip includes a rear end positioned to lie on a rear portion of the seat pan adjacent to a lower portion of the seat back and an opposite front end positioned to lie on a front portion of the seat pan in spaced-apart relation to the seat back, and each bladder-receiving space is arranged to extend in a direction away from the seat back between the rear and front portions of the seat pan, each of the first, second, third, seventh, eighth, and ninth deformable strips have a first width, each of the fourth, fifth, and sixth deformable strips have a relatively wider second width, and the inflatable bladders are arranged to lie in series in spaced-apart relation to one another to provide a generally uniform first lateral distance between each of the first and second inflatable bladders, the second and third inflatable bladders, the sixth and seventh inflatable bladders, and the seventh and eighth inflatable bladders and a relatively larger and generally uniform second lateral distance between each of the third and fourth inflatable bladders, the fourth and fifth inflatable bladders, and the e fifth and sixth inflatable bladders.

Clause 10. The vehicle seat of any preceding clause, wherein the seat pan includes a front edge, a left-side edge that extends toward the front edge in a direction away from the seat back, and a right-side edge that extends toward the front edge in a direction away from the seat back and lies in laterally spaced-apart relation to the left-side edge, each inflatable bladder is arranged to extend laterally from the right-side edge of the seat pan to the left-side edge of the seat pan.

Clause 11. The vehicle seat of any preceding clause, wherein each inflatable bladder has a cross-sectional shape that varies along the length thereof.

Clause 12. The vehicle seat of any preceding clause, wherein each inflatable bladder includes a concave top edge arranged to face upwardly away from the underlying seat pan.

Clause 13. The vehicle seat of any preceding clause, wherein the seat bottom is a pad that includes the variable-firmness cushion and a cushion cover formed to include a cushion-receiving chamber containing the variable-firmness cushion therein.

Clause 14. The vehicle seat of any preceding clause, wherein the strip retainer is a strip-containment bag formed to include a strip-storage chamber containing the deformable strips and the inflatable bladders and the strip containment bag is located in the cushion-receiving chamber of the cushion cover.

Clause 15. The vehicle seat of any preceding clause, wherein the strip retainer is an endless strip-retainer strap that is arranged to extend in sequence around a left side, a top side, a right side, and a bottom side of the deformable elastic bed, the bottom side faces downwardly toward the seat pan, and the top side faces upwardly away from the seat pan.

Clause 16. The vehicle seat of any preceding clause, wherein the strip retainer is an endless strip-retainer band that is arranged to extend in sequence around a left side, a rear side, a right side, and a front side of the deformable elastic bed while a bottom side of the deformable elastic bed faces downwardly toward the seat pan and a top side of the deformable elastic bed faces upwardly away from the seat pan.

Clause 17. The vehicle seat of any preceding clause, wherein the layer-firmness changer further includes a strip retainer configured to provide means for retaining the series of deformable strips in side-by-side relation to one another during deformation of the deformable strips.

Clause 18. The vehicle seat of any preceding clause, wherein the deformation of the deformable strips is caused
in one instance by inflation of the inflatable bladder using a pressurized fluid from the pressurized source and a resulting expansion in size of each of the inflatable bladders and
in another instance by deflation of the inflatable bladder to discharge the pressurized fluid to the pressurized source and a resulting contraction in size of the inflatable bladder
so that firmness of the deformable layer is increased in response to inflation of the inflatable bladders and is decreased in response to deflation of the inflatable bladders.

Clause 19. The vehicle seat of any preceding clause, wherein the deformable layer and the layer-firmness changer cooperate to form a variable-firmness cushion included in a seat bottom.

Clause 20. The vehicle seat of any preceding clause, further comprising a seat pan underlying and supporting the seat bottom including the deformable layer and a seat back extending upwardly from the seat bottom.

Clause 21. The vehicle seat of any preceding clause, wherein the deformable layer includes several deformable strips, each deformable strip includes
a rear end positioned to lie on a rear portion of the seat pan adjacent to a lower portion of the seat back and
an opposite front end positioned to lie on a front portion of the seat pan in spaced-apart relation to the seat back,
each bladder-receiving space being arranged to extend in a direction away from the seat back between the rear and front portions of the seat pan.

Clause 22. The vehicle seat of any preceding clause, wherein the deformable layer includes several deformable strips, each deformable strip includes
a left-side end positioned to lie on a left-side edge of the seat pan extending toward a front edge of the seat pan in a direction away from the seat back adjacent to a lower portion of the seat back and
a right-side end positioned to lie on a right-side edge of the seat pan extending toward the front edge in the direction away from the seat back and in laterally spaced-apart relation to the left-side edge,
each inflatable bladder is arranged to extend laterally from the right-side edge of the seat pan to the left-side edge of the seat pan.

Clause 23. The vehicle seat of any preceding clause, wherein a first inflatable bladder is located in a first bladder-receiving space provided between a first and a second of the deformable strips, and at least a second inflatable bladder is located in a second bladder-receiving space provided between the second and a third of the deformable strips.

Clause 24. The vehicle seat of any preceding clause, wherein a third inflatable bladder is located in a third bladder-receiving space provided between the third and a fourth of the deformable strips, a fourth inflatable bladder is located in a fourth bladder-receiving space provided between the fourth and a fifth of the deformable strips, and a fifth inflatable bladder is located in a fifth bladder-receiving space provided between the fifth and a sixth of the deformable strips.

Clause 25. The vehicle seat of any preceding clause, wherein at least one of the inflatable bladders has a triangular cross-sectional shape.

Clause 26. The vehicle seat of any preceding clause, wherein the triangular cross-sectional shape is isosceles and a base of the isosceles-shaped inflatable bladder is located in close proximity to the seat pan and a tip of the isosceles-shaped inflatable bladder is arranged to lie in spaced-apart relation to the seat pan to extend away therefrom.

Clause 27. The vehicle seat of any preceding clause, wherein some of the deformable strips have a first width and some of the other deformable strips have a second width.

Clause 28. The vehicle seat of any preceding clause, wherein some of the inflatable bladders are arranged to lie in series in spaced-apart relation to one another to provide a uniform first distance between each of the inflatable bladders and some of the other inflatable bladders are arranged to lie in series in spaced-apart relation to one another to provide a second distance between the other inflatable bladders.

Clause 29. The vehicle seat of any preceding clause, wherein the inflatable bladder has a cross-sectional shape that varies along the length thereof.

Clause 30. The vehicle seat of any preceding clause, wherein the inflatable bladder includes a concave top edge arranged to face upwardly away from the underlying seat pan.

Clause 31. The vehicle seat of any preceding clause, wherein the seat bottom is a pad that includes the variable-firmness cushion and a cushion cover formed to include a cushion-receiving chamber containing the variable-firmness cushion therein.

Clause 32. The vehicle seat of any preceding clause, wherein the strip retainer is a strip-containment bag formed to include a strip-storage chamber containing the deformable strips and the inflatable bladders and the strip containment bag is located in the cushion-receiving chamber of the cushion cover.

Clause 33. The vehicle seat of any preceding clause, wherein the strip retainer is an endless strip-retainer strap that is arranged to extend in sequence around a left side, a top side, a right side, and a bottom side of the deformable layer, the bottom side faces downwardly toward the seat pan, and the top side faces upwardly away from the seat pan.

Clause 34. The vehicle seat of any preceding clause, wherein the strip retainer is an endless strip-retainer band that is arranged to extend in sequence around a left side, a rear side, a right side, and a front side of the deformable layer while a bottom side of the deformable layer faces downwardly toward the seat pan and a top side of the deformable layer faces upwardly away from the seat pan.

1. A vehicle seat comprising
a deformable elastic bed including a series of deformable strips made of elastic material and arranged to lie in side-by-side relation to one another and
a bed-firmness changer including a strip deformer comprising several inflatable bladders, each inflatable bladder being positioned to lie in a bladder-receiving space provided between a companion pair of adjacent deformable strips included in the deformable elastic bed and adapted to be coupled in fluid communication to a pressurized fluid source and a strip retainer configured to provide means for retaining the series of deformable strips in side-by-side relation to one another during deformation of the series of deformable strips caused in one instance by inflation of each inflatable bladder using pressurized fluid from the pressurized fluid source and a resulting expansion in size of each of the inflatable bladders and in another instance by deflation of each inflatable bladder to discharge pressurized fluid to the pressurized fluid source and a resulting contraction in size of each of the inflatable bladders so that firmness of the deformable elastic bed is increased in response to inflation of the inflatable bladders and is decreased in response to deflation of the inflatable bladders.

2. The vehicle seat of claim 1, wherein the deformable elastic bed and the bed-firmness changer cooperate to form a variable-firmness cushion included in a seat bottom and further comprising a seat pan underlying and supporting the seat bottom and a seat back extending upwardly from the seat bottom.

3. The vehicle seat of claim 2, wherein the deformable elastic bed includes six deformable strips, each deformable strip includes a rear end positioned to lie on a rear portion of the seat pan adjacent to a lower portion of the seat back and an opposite front end positioned to lie on a front portion of the seat pan in spaced-apart relation to the seat back, and each bladder-receiving space is arranged to extend in a direction away from the seat back between the rear and front portions of the seat pan.

4. The vehicle seat of claim 3, wherein a first inflatable bladder is located in a first bladder-receiving space provided between a first and a second of the deformable strips, a second inflatable bladder is located in a second bladder-receiving space provided between the second and a third of the deformable strips, a third inflatable bladder is located in a third bladder-receiving space provided between the third and a fourth of the deformable strips, a fourth inflatable bladder is located in a fourth bladder-receiving space provided between the fourth and a fifth of the deformable strips, and a fifth inflatable bladder is located in a fifth bladder-receiving space provided between the fifth and a sixth of the deformable strips.

5. The vehicle seat of claim 2, wherein at least one of the inflatable bladders has a triangular cross-sectional shape.

6. The vehicle seat of claim 5, wherein the triangular cross-sectional shape is isosceles and a base of the isosceles-shaped inflatable bladder is located in close proximity to the seat pan and a tip of the isosceles-shaped inflatable bladder is arranged to lie in spaced-apart relation to the seat pan to extend away therefrom.

7. The vehicle seat of claim 2, wherein the deformable elastic bed includes nine deformable strips, each deformable strip includes a rear end positioned to lie on a rear portion of the seat pan adjacent to a lower portion of the seat back and an opposite front end positioned to lie on a front portion of the seat pan in spaced-apart relation to the seat back, and each bladder-receiving space is arranged to extend in a direction away from the seat back between the rear and front portions of the seat pan, each of the first, second, third, seventh, eighth, and ninth deformable strips have a first width, each of the fourth, fifth, and sixth deformable strips have a relatively wider second width, and the inflatable bladders are arranged to lie in series in spaced-apart relation to one another to provide a generally uniform first lateral distance between each of the first and second inflatable bladders, the second and third inflatable bladders, the sixth and seventh inflatable bladders, and the seventh and eighth inflatable bladders and a relatively larger and generally uniform second lateral distance between each of the third and fourth inflatable bladders, the fourth and fifth inflatable bladders, and the fifth and sixth inflatable bladders.

8. The vehicle seat of claim 2, wherein the seat pan includes a front edge, a left-side edge that extends toward the front edge in a direction away from the seat back, and a right-side edge that extends toward the front edge in a direction away from the seat back and lies in laterally spaced-apart relation to the left-side edge, each inflatable bladder is arranged to extend laterally from the right-side edge of the seat pan to the left-side edge of the seat pan.

9. The vehicle seat of claim 8, wherein each inflatable bladder has a cross-sectional shape that varies along the length thereof.

10. The vehicle seat of claim 8, wherein each inflatable bladder includes a concave top edge arranged to face upwardly away from the underlying seat pan.

11. The vehicle seat of claim 2, wherein the seat bottom is a pad that includes the variable-firmness cushion and a cushion cover formed to include a cushion-receiving chamber containing the variable-firmness cushion therein.

12. The vehicle seat of claim 11, wherein the strip retainer is a strip-containment bag formed to include a strip-storage chamber containing the series of deformable strips and the inflatable bladders and the strip-containment bag is located in the cushion-receiving chamber of the cushion cover.

13. The vehicle seat of claim 11, wherein the strip retainer is an endless strip-retainer strap that is arranged to extend in sequence around a left side, a top side, a right side, and a bottom side of the deformable elastic bed, the bottom side faces downwardly toward the seat pan, and the top side faces upwardly away from the seat pan.

14. The vehicle seat of claim 11, wherein the strip retainer is an endless strip-retainer band that is arranged to extend in sequence around a left side, a rear side, a right side, and a front side of the deformable elastic bed while a bottom side of the deformable elastic bed faces downwardly toward the seat pan and a top side of the deformable elastic bed faces upwardly away from the seat pan.

15. A vehicle seat comprising
a deformable layer including a series of deformable strips made of elastic material and arranged to lie in side-by-side relation to one another and
a layer-firmness changer including a strip deformer comprising at least one inflatable bladder, the inflatable bladder being positioned to lie in a bladder-receiving space provided between a pair of adjacent deformable strips included in the deformable layer and adapted to be coupled in fluid communication to a pressurized source.

16. The vehicle seat of claim 15, wherein the layer-firmness changer further includes a strip retainer configured to provide means for retaining the series of deformable strips in side-by-side relation to one another during deformation of the series of deformable strips.

17. The vehicle seat of claim 16, wherein the deformation of the series of deformable strips is caused in one instance by inflation of the inflatable bladder using a pressurized fluid from the pressurized source and a resulting expansion in size of each of the inflatable bladders and in another instance by deflation of the inflatable bladder to discharge the pressurized fluid to the pressurized source and a resulting contraction in size of the inflatable bladder so that firmness of the deformable layer is increased in response to inflation of the inflatable bladders and is decreased in response to deflation of the inflatable bladders.

18-19. (canceled)

20. The vehicle seat of claim 17, wherein the deformable layer includes several deformable strips, each deformable strip includes a rear end positioned to lie on a rear portion of a seat pan adjacent to a lower portion of a seat back and an opposite front end positioned to lie on a front portion of the seat pan in spaced-apart relation to the seat back, each bladder-receiving space being arranged to extend in a direction away from the seat back between the rear and front portions of the seat pan.

21. The vehicle seat of claim 17, wherein the deformable layer includes several deformable strips, each deformable strip includes a left-side end positioned to lie on a left-side edge of a seat pan extending toward a front edge of the seat pan in a direction away from a seat back adjacent to a lower portion of the seat back and a right-side end positioned to lie on a right-side edge of the seat pan extending toward the front edge in the direction away from the seat back and in laterally spaced-apart relation to the left-side edge, each inflatable bladder is arranged to extend laterally from the right-side edge of the seat pan to the left-side edge of the seat pan.

22-23. (canceled)

24. The vehicle seat of claim 17, wherein at least one of the inflatable bladders has a triangular cross-sectional shape and the triangular cross-sectional shape is isosceles and a base of the isosceles-shaped inflatable bladder is located in close proximity to a seat pan and a tip of the isosceles-shaped inflatable bladder is arranged to lie in spaced-apart relation to the seat pan to extend away therefrom.

25-34. (canceled)
